(19) United States
(12) Patent Application Publication
(10) Pub. No.: US 2015/0059535 A1
(43) Pub. Date: Mar. 5, 2015

(54) Locking V Hinge Tool Device

(71) Applicant: Vernon James Ford, JR., (US)

(72) Inventor: Vernon James Ford, JR., Palm Bay, FL (US)

(21) Appl. No.: 14/016,298

(22) Filed: Sep. 3, 2013

(51) Int. Cl. B25B 13/32; B25B 13/38

(52) U.S. Cl. CPC B25B 13/32; B25B 13/38
USPC 81/116

(57) ABSTRACT

The locking V hinge tool of this invention comprises three or more pieces. The first two pieces are fundamentally identical and reversed, comprised of three main sections in optional order of, a jaw end, a common axle, and a arc-like cam, assembled together and rotate through the common axle, allowing the jaw ends to open and close. A third pin holding piece holds a pin that rides in and moves, the criss-crossing arc-like slots in the other pieces, at or near an angle aimed at the corners of a diamond like opening where the two arc-like slots intersect. Any external force exerted on the jaw ends, attempt to force the pin in the arc-like slots to rise to an upright position but are blocked by the walls.

This invention relates to a locking device and, more particularly, to a self-locking tool that will lock an object held therein.

### BACKGROUND OF THE INVENTION

It is known to use various tools for holding and locking work objects in place. There are other tools which utilize connecting parts that are rotatable upon a common axis. Some of these tools are disclosed in U.S. Pat. Nos. 682,701; 644,825; 1,026,270; 1,401,931; 1,450,875; 1,717,726; 2,370,308; 2,574,909; 2,787,925; 3,126,775; 3,257,878; and 4,633,558; 5,005,450; 6,662,690 In U.S. Pat. No. 682,701 (Howland) a locking pliers is disclosed having a plurality of pieces movable along a multitude of pivot points. There is a central pivot A having 5 or 6 separate pieces movable thereabout. When the pliers of Howland is in the locked position an object is held between jaws B and C which are in turn pivotally connected to D, H, J and r. Howland's device is relatively complex in usage and construction. Both handles of Howland's also must be held at all times during use in order to maintain an object locked in position. Also, Howland requires a high friction surface to function properly.

U.S. Pat. No. 644,825 (Jensen) discloses a wrench having handle means that can be locked in place by a spring means n. The spring is positioned on the bottom portion of one of the handles. When pin g of Jensen is pressed out of the socket h, it is slid into the socket g and spring n holds it in place. The holding device of Jensen is again relatively complex in construction and would be relatively expensive to manufacture.

U.S. Pat. No. 1,026,270 (Leonard) discloses a pipe wrench with a holding device to permit the wrench to be applied to a pipe or rod. A spring 15 in Leonard engages the handle 13 and its opposite end is secured to the shank of the wrench. The spring 15 locks the handle in position between the jaws 5 and 6. As in many locking tools, Leonard relies upon a spring means to provide the locking mechanism in his device.

In Whelan U.S. Pat. No. 1,401,931 an adjustable pipe wrench is disclosed which uses a quadrant attachment element together with two jaws to hold an object in position. The wrench of Whelan holds pipes or the like of various diameters with a three point grip, each of the three elements having a gripping surface. McGill U.S. Pat. No. 1,717,726 and Burrows U.S. Pat. No. 2,574,909 each disclose wrenches having holding means to tightly hold items. Each discloses a wrench having several parts and several focal points for each part. Included in both patents are adjusting means to tighten or loosen objects held within the jaw assemblies of the respective wrenches.

In Teselsky U.S. Pat. No. 1,450,875 a pliers is disclosed having a third jaw section that will co-act with the other two jaws of the pliers to prevent the article gripped from slipping. Handle means 5 and 6 of Teselsky each terminate with a jaw section, these jaw sections have a shank mounted around the exterior portion of one of the jaws. This shank acts as a third jaw which co acts in a gripping operation.

Hanson U.S. Pat. No. 2,370,308 has a circular cam that can wedge a nut and hold it in position with handles grasped or under moderate pressure.

Buchanon, U.S. Pat. No. 2,787,925, has used rotational sliding cams for movement of socket like wedges,

Ramge, U.S. Pat. No. 3,126,775. Uses a Rotational wedge for temporary hold using cams.

Anderson, U.S. Pat. No. 3,257,878 a crescent wrench with rack means of locking a jaw with axle motion and with means to further adjust the jaw, not necessarily in a locking manor.

Spaulding, U.S. Pat. No. 4,633,558, discloses a tool for applying a spring clamp to an object. Spaulding utilizes a cam which is carried by one of the jaws and a pair of side plates pivotally supported by the other of said jaws having cam control tracks therein for affecting and controlling radial movement of said cam to complete closure of said clamp. There are means on a jaw for controlling rotation of the cam and the cam is engaged to a hook portion to the spring clamp to effect closure.

Ford U.S. Pat. No. 5,005,450 Self-locking tool locks both the pin and radial around an axle point only and locks by angle of pins in cams included in the handle pieces. Curved slots being expensive to produce.

Ford U.S. Pat. No. 5,033,338 Self-locking Device locks both the pin and radials around an axle point only in a pliers or socket like manor, where part of the locking mechanism is one of the handles which in turn is used as leveraged pressure to move the jaw section, and in that way angle and lock the pin in position using all three plates. The movement or rotation of the plate is from an external motion not the force of the jaw.

In Ploeger U.S. Pat. No. 6,662,690 Discloses a Pliers for clamping a hose or tube which moves a pin only to a radial angle, using a tan genial slot wall to hold it temporarily. It allows for a very limited movement around a central axle with limited stability.

All of the above prior art devices are relatively complex in structure, most require springs for a locking effect and several are complicated to use. There is a need for a relatively simply-constructed tool that will lock an object in position without the need for springs or other such means.

### SUMMARY OF THE INVENTION

It is therefore an object of this invention to provide a locking tool devoid of the above-noted disadvantages.

Another object of this invention is to provide a locking tool having two handle means wherein only one needs to be held after pressure has effected a locking of the object.

Another still further object of this invention is to provide a tool having a cam leverage to align and control the tilt the pin thereby locking the tool.

Yet another object of this invention is to effectively align and control the tilt of the locking pin so that a variety of thicknesses and cam slopes can be used while still actively holding the pin in a jammed locked position as opposed to a frictional hold.

A still further object of this invention is to provide a locking tool that can be used to easily lock and release an object held therein, also in both an open or closed direction.

Yet another object of this invention is to provide a locking tool that is relatively simple in construction and relatively inexpensive to use.

Still another object of this invention is to provide a locking tool that is relatively easy to use yet effective in holding an object securely.

Still yet a further object of this invention is to provide a tool that has means to lock in two directions; rotationally counter-clockwise, and clockwise.

Yet still a further object of this invention is to provide a locking tool wherein once the lock is effected, handle pressure can be released without affecting the lock.

Still yet a further object of this invention is to allow a wide variety of handle and jaw attachments and systems to be used with this toothless ratcheting system.

Yet another object of this invention is to use the jaw motion and locking to additionally control additional jaw pieces and associate their function to the primary jaw motion and locking.

Still a further object of this invention is to allow handle and jaw attachments to affect locking pin angle and to form axis points of the axle and cam pin to rotate the plates for further leveraging and control.

Still another further object of this invention is to allow that an over center linkage may be added to one or more of the jaw section by extending the handle section of the linkage beyond the handle to jaw connection, so that the primary leveraging handle of such linkage can be rotated in both rotational directions as in a toggle, to effectively open and close jaw or other linkage, in such a manor to effect an over center lock or to allow squeezing on the jaw section, with or without having to place fingers in between the handles.

Still another further object of this invention is to allow that an over center linkage may be added to one or more of the jaw section for any and all locking pliers or regular pliers, so that the primary leveraging handle of such linkage can be rotated in both rotational directions as in a toggle by extending the handle section of the linkage beyond the handle to jaw connection, to effectively open and close jaw or other linkage, in such a manor to effect an over center lock or to allow squeezing on the jaw section, with or without having to place fingers in between the handles, and thus eliminating or augmenting a handle opening spring.

Yet another object of this invention is to allow movement of the jaws by a pin in the slots and control the tilt of that pin to allow locking and then further increase or decrease in that tilt to further move the jaws by means of the pin effecting the cam slots.

Still another object of this invention is a pliers or over center leveraged locking pliers like tool wherein the release of locking tension can be formed in the upper or lower end, opposite the locking handle of a toggle like handle on the outside and extended upward or downward section of the handle, so that push down on this extension, towards the jaw or body of the tool would have higher leverage to be able to move the handle linkage over center locking and release the lock, so that it is easier to get at and does not have fingers inside the handle.

Still a further object of this invention is to have a tool that can be applied and locked on a V like edges of but not limited to, bars, rails, cam slots at any point on the V edge corresponding to the position and movement of the locking pin.

Still another object of this invention is a pliers or over center locking pliers like tool wherein there exists an adjustable distance on the over center handle or toggle handle to the linkage to the body of the tool, such that a wedge, screw, cam or any control means to increase or decrease the distance in the linkage, allowing for segmented or variable leveraging advantage with or without requiring re-adjustment of pressure screw or slide piece or any other means for pressure distance, allowing for large squeeze and grasping use or tight extreme high leverage pressure.

Still a further object of this invention is to act as a locking hinge like device, to hold and lock in position relative to the position of the third plate locking pin in the cam slots, so that any external pressure or shock to the jaws will have no effect on jaw movement.

These and other objects are accomplished by the present invention by providing a locking tool comprising in combination two handle pieces and a third or remaining piece. Two handle pieces have a jaw, arc-like slots and an axle point. They are reversed so the arc-like slots oppose each other and connect together at the axle point. A Third piece has a hole for a pin to go through. This pin rides inside the arc-like slots of the two handle pieces. As it rides up/down in the slots, it opens/closes the jaw sections of the two handle pieces.

The arc-like slots in the first handle piece and second handle piece spiral in the opposite directions which is critical to the present invention. When the first and second handle pieces are stacked and assembled with the third remaining piece, the spiraling slots are of approximately the same size, spiral in the opposite direction, have substantially the same arc-radius and are substantially identical in configuration. They must be aligned in at least a portion with the opening of the hole in the third piece so that a locking pin can fit in an opening. The locking pin extends through the slots in the two pieces and through this diamond like shaped opening.

When the third piece and it's alignment of the pin in it's hole, are slid up/down the length of the handles, the pin pushes on the slot walls causing the two handle pieces to open or close. When an object is placed in the jaw section, any motion applied to the jaws cause the pin in the slot to attempt to point in one of the four corners formed by the overlapping slots into a diamond like opening and to attempt to become aligned to the slot walls. The angled slot third piece's pin having caps on both ends, and already aligned by the third piece hole, misaligns slightly more in the arc slots, held in place by the top and bottom edges of the respective cam slots on the two handle pieces, as the pin is forced to slanted further towards the diamond like corners, and not in the direction needed with the opening and closing directional curvature direction of the arc-like slot in both the first and second pieces. The curvature of the one piece's (opposite to the direction of the pin tilt), arc-like slot wall at each level or layer of the pin position, blocks pin movement down or up the arc-like slot of the other piece's arc-like slot, and thus jaws are held in place.

Release involves moving the third piece and it's pin so that the pin is realigned against the cam slot walls in a new position along the arc-like slots. An additional pin or guides maybe used to keep the diagonal of the pin in the proper direction. Sliding pieces may be inserted into the cam slots for the locking pins to fit through so that surface area of pins as the affect the cam slots can be increased.

All of the slots in the three pieces should have a width dimension slightly more than the diameter of the pin to permit it to be freely movable therein. In a preferred embodiment of the invention one slot is used in each of the three pieces, however, more than one slot in each can function equally well. While there can be one slot or a plurality of slots in each of the three pieces, there must be at least one slot in each piece and at least one axle pin and at least one locking pin. Multiple layers of plates can be laminated and used to both support and position the locking pin. External forces can be applied to the pin to control it's locking angle and for leverage purposes.

When an object is to be grasped in the jaws of this tool, the third piece needs to be slid up or down to cause the first and second piece to move together. The axle points on each one of these pieces can then be separated by handles or linkage to affect a rotation around the third piece's pin causing the jaws to tighten. Off center cam or over centered linkage and leverage systems can be used either in stand alone vise like action or rotational holding and or locking.

Additional jaws may be placed on either side of the axle points of the first and second pieces. The third piece can be a strip guided for movement on one of the two handle pieces with teeth like edge that can be used for ratchet type movement. The angle of the hole or pin of the third piece may be wedged externally or otherwise to increase or decease desired affect.

An additional fifth piece being a copy of either one of the handle pieces but without the connection to the main axle piece, and with connection of this piece at or near the jaw section of the first or second handle piece having the arc-like slots in the same direction. the corresponding same arc-like slot in the same direction piece would have it jaw section removed, and the jaw section of this fifth piece would be used instead. movement of an object in the jaws would rotate this fifth piece around its own axle up by the jaw section and thus rotating the curve arc-like slot against the third piece pin holding said pin in a rotational or horizontal direction, preventing movement of the jaws in reverse.

Additional linkage can be added to allow that an over center linkage may be added to one or more of the jaw section of this tool or to any pliers or locking pliers type tool, so that the primary leveraging handle of such linkage can be rotated in both rotational directions as in a toggle, to effectively open and close jaw or other linkage, in such a manor to effect an over center lock or to allow squeezing on the jaw section, with or without having to place fingers in between the handles. The handle section of the linkage is extended over the jaw connection thus eliminating or augmenting the customary spring.

Release of locking tension can occur in the upper or lower end, opposite the locking handle of a toggle like handle on the outside and extended upward or downward section of the handle, so that pushing down on this extension, towards the jaw or body of the tool, against the over centered connection, would have higher leverage to be able to move the handle linkage over center locking and release the lock. In normal toggle motion it would be held in place by a spring or bump and act as a return of the handle in a toggle see-saw manor.

An adjustable distance on the over center handle or toggle handle to the linkage to the body of the tool, such that a wedge, screw, cam or any control means to increase or decrease the distance in the linkage, allowing for segmented or variable leveraging advantage with or without requiring re-adjustment of pressure screw or slide piece or any other means for pressure distance, allowing for large squeeze and grasping use or tight extreme high leverage pressure.

The tool of this invention can be used in hand tools such as pliers or wrenches or in vices, other gripping devices, hinging devices with position locking and as a differential clutching, locking device, and positioning to the relative speeds of rotation of the plates.

### BRIEF DESCRIPTION OF THE DRAWING

FIG. 1 is a plan top view of the assembled locking tool of this invention.

FIG. 2 A is a plan top view of the disassembled locking tool of this invention, bottom piece,

FIG. 2 B is a plan top view of the pin holding piece of the disassembled locking tool of this invention.

FIG. 2 C is top piece as a reflection of piece 1.

FIG. 3 is a plan top view of the assembled locking tool of this invention with a wrench like handle.

FIG. 4 A is a plan top view of the disassembled locking tool of this invention with a wrench like handle as the pin holding piece,

FIG. 4 B is a plan top view of the disassembled locking tool of this invention as the bottom piece

FIG. 4 C a plan top view of the disassembled locking tool of this invention as the top piece.

FIG. 5 is a plan top view of the partial assembled locking tool of this invention with one piece showing a diamond like opening where the cam slots intersect.

FIG. 6 is a sliced side view of the assembled locking tool of this invention showing one example of stacking of pieces

FIG. 7 is a plan top view of the assembled locking tool of this invention with a fourth handle piece and connection to affect rotation of the axle around the cam pin.

FIG. 8 is a plan top view of the assembled locking tool of this invention with an example of an additional jaw assembly connected to the original first and second piece.

FIG. 9 is a plan top view of the assembled locking tool of this invention with a fourth handle piece and a tooth connection to the pin controlling third piece

FIG. 10 is a plan top view of the assembled locking tool of this invention with a fourth handle piece and direct connection piece to the third piece

FIG. 11 is a plan top view of the assembled locking tool of this invention with a fourth handle piece and direct connection piece to the third piece while the fourth handle is attached to a leveragable jaw head.

FIG. 12 is a plan top view of the assembled locking tool of this invention with a fourth handle piece and direct connection piece to the common axle, while the fourth handle is attached to a leveragable jaw head and a slide edge located on the forth handle piece to move the connection closer to the jaw addition

FIG. 13 is a plan top view of the assembled locking tool of this invention with a fourth handle piece and direct connection piece to the common axle, while the fourth handle is attached to a leveragable jaw head and a cam wheel located on the forth handle piece to move the connection closer to the jaw addition

FIG. 14 is a plan top view of the assembled locking tool of this invention placed on a V Edged object with the jaw position attached to an associated position along the V like edge, while the common axle and third piece pin ride a cam down the center.

FIG. 15 A is a top view of the partial disassembled locking tool of this invention that was placed on a V edged object. as a top view of the V like edged piece,

FIG. 15 B is the assembled locking tool of this invention with holes for attachment.

FIG. 16 is a side view of a third piece pin acting as the third piece holding its own angle.

### DETAILED DESCRIPTION OF THE DRAWINGS AND PREFERRED EMBODIMENTS

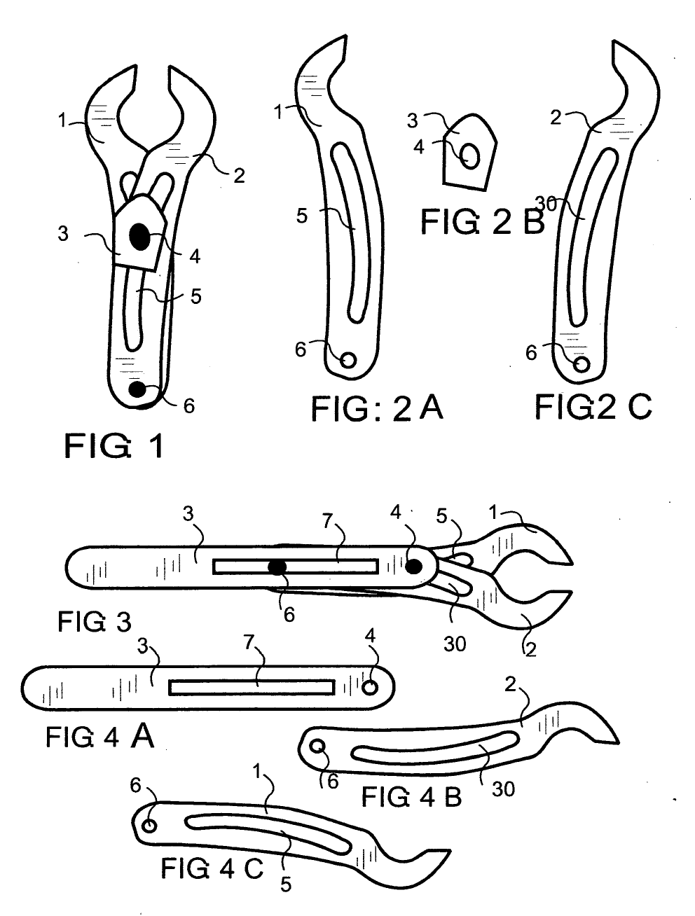

In FIG. 1 the locking tool of this invention is illustrated in its assembled condition. The tool comprises in this embodiment three main component pieces, a first handle piece 1, a second handle piece 2 and a third piece 3.

As shown in FIG. 2 A, The first handle piece 1 has in its upper portion a jaw section and below the jaw section and arc-like slot section 5, an axle aperture 6. By “below” is meant when piece is held vertically, at the top portion would be jaw and “below” would be located axle aperture 6. Below the jaw section in first handle piece 1 is a first arc-like slot 5 through which a pin 4 will extend and travel. pin 4 will also travel in and extend through a arc-like slot 30 in second handle piece 2.

In FIG. 2 B a pin holder piece is shown, holding the connecting pin and can ride in cam slots 5 and 30 respectively.

As shown in FIG. 2 C, Piece 2 is identical and reversed of FIG. 2 A.

FIG. 3 is a plain top view of the assembled locking tool of this invention in a half way opened position. The third piece is extended and a cam slot 7 holds the common axle 6 of the first and second piece. As piece 3 slide up/down the tool pushing pin 4 in slots 5 and 30 to open/close jaws.

FIG. 4 A shows piece 3 with elongated axle slot 7 and pin holder hole 4.

FIG. 4B shows piece 2 with it's axle hole 6 and cam slot 30 and jaw section 2

FIG. 4 C shows piece which is identical but reversed of FIG. 4 B.

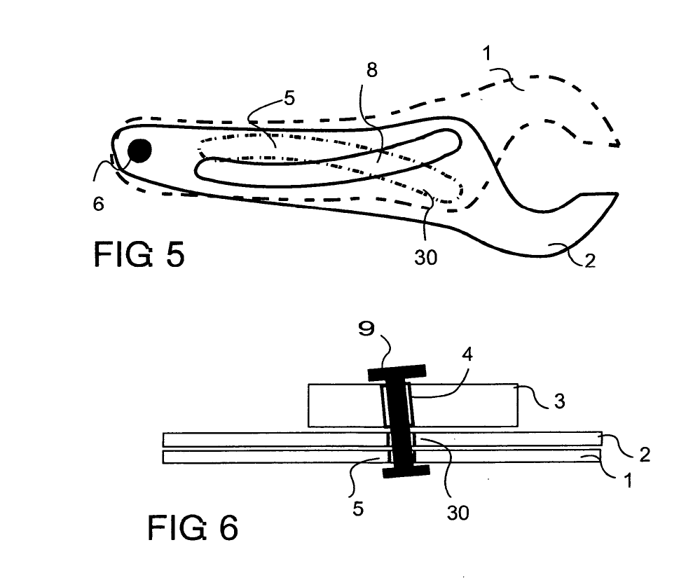

FIG. 5 is a plain top view of the partial assembled locking tool of this invention in a half way opened position. Piece 1 is see through and piece 2 is a solid line drawing. Diamond like opening 8 is illustrated where the cam slots of the first 1 and second 2 plates intersect.

FIG. 6 is a side view showing stacking of pieces 1, 2, and 3, and diagonal pin 9 in piece 3 and in the slots 5 and 30 of pieces 1 and 2.

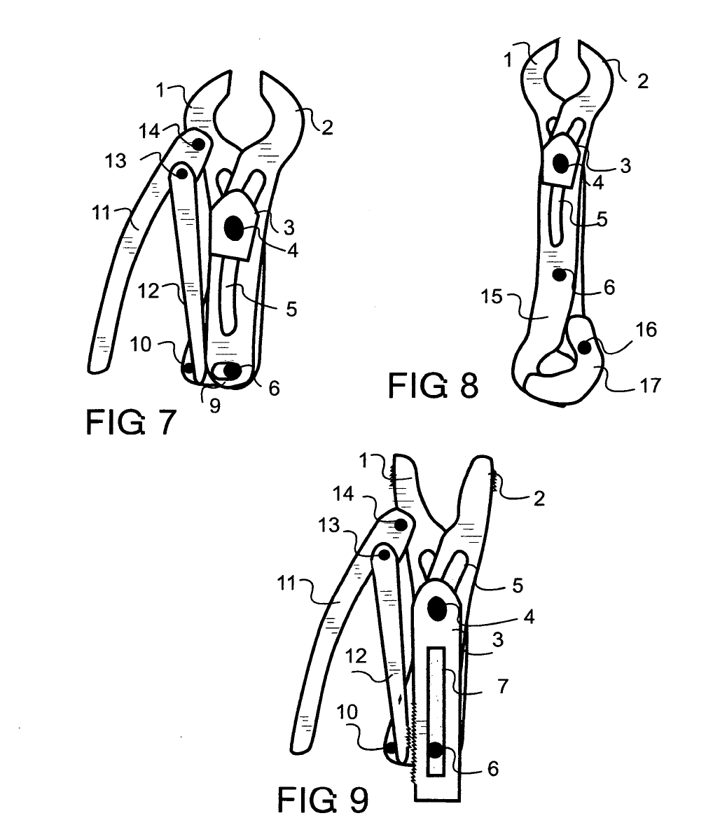

FIG. 7 is a top view showing the assembled locking tool of this invention in a half way opened position. Piece 1 has been extended by axle 6 to include a connection guiding pin 10. It also now has a hole near the jaw for connection at axle 4 to fourth handle piece 11. Piece 2 has an extended axle slot 9 to rotate piece 2 around cam pin 4 to move the jaw section of piece 2. Fourth handle 11 in addition to being mounted to the jaw section of plate 1 at hole 14, also has a hole for connection piece 12. Piece 12 connects to fourth handle 11 at hole 13 and wedges down between lower piece 2 and guiding pin 10.

FIG. 8 is a top view showing the assembled locking tool of this invention with the lower ends of piece 1 and piece 2 extended past the common axle 6 forming a secondary set of jaws. An attachment jaw 17 has been attached at axle 16 to piece 1 such that it rotates as piece 2 moves rationally. The movement of jaw 17 in this case is to assist in surrounding any object in the extended jaw sections of piece 1 and piece 2.

FIG. 9 is a top view showing the assembled locking tool of this invention in a half way opened position. Piece 1 has been extended by axle 6 to include a connection guiding pin 10. It also now has a hole near the jaw for connection to fourth handle piece 11. Piece 2 has an extended axle slot to rotate piece 2 around cam pin 4 to move the jaw section of piece 2. Fourth handle 11 in addition to being mounted to the jaw section of plate 1 at hole 14, also has a hole for connection piece 12. Piece 12 connects to fourth handle 11 at hole 13 and move by means of a tooth connection, onto the extended third piece 3 as shown with a cam slot 7 for common axle 6.

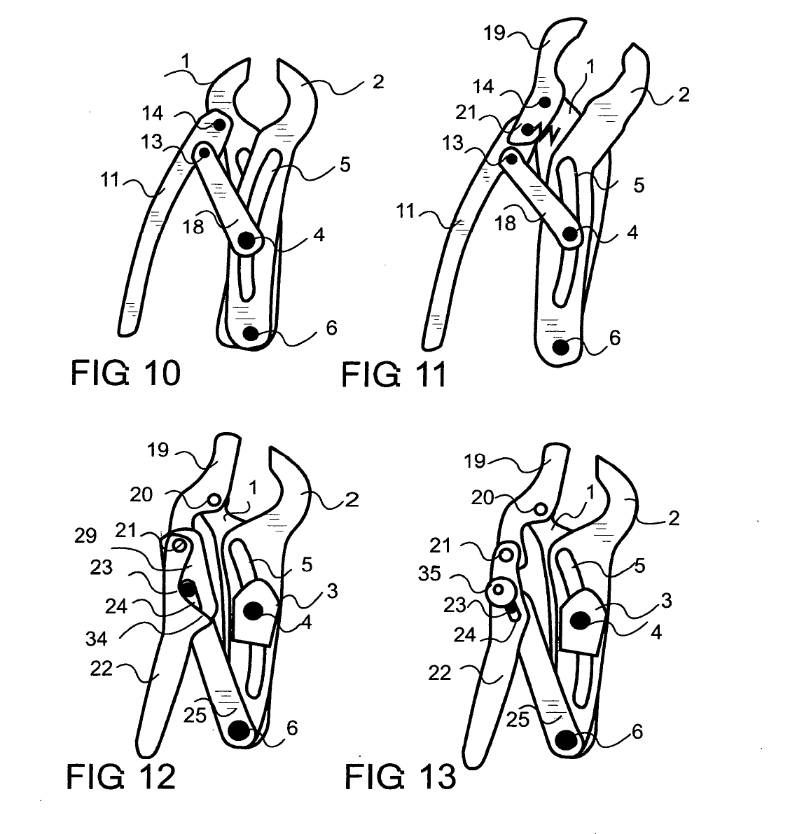

FIG. 10 is a plain top view of the assembled locking tool of this invention with a fourth handle piece and direct connection piece to the third piece. Piece 1 now has a hole near the jaw for connection to fourth handle piece 11. Fourth handle 11 in addition to being mounted to the jaw section of plate 1 at hole 14, also has a hole for connection piece 12. Piece 12 effectively becomes the third piece and connects directly to pin in hole 4 to the cam slots 30 of piece 2 and 5 of piece 1. FIG. 11 is a plain top view of the assembled locking tool of this invention with a fourth handle piece and direct connection piece to the third piece while the fourth handle is attached to a leveragable jaw head. Piece 1 now has a hole near the jaw for connection to jaw head piece 19. jaw piece 19 also has a connection for piece 11 at hole 21 Fourth handle 11 in addition to being mounted to the jaw piece 19 at hole 21, also has a hole for connection piece 12. Piece 12 effectively becomes the third piece and connects directly to pin in hole 4 to the cam slots 30 of piece 2 and 5 of piece 1.

FIG. 12 is a plain top view of the assembled locking tool of this invention with a fourth handle piece 22 and direct connection piece 25 to the common axle 6, while the fourth handle 22 is attached to a leveragable jaw head 19 and a slide edge 34 located on the forth handle piece to move the connection 23 closer to the jaw pivot. Piece 29 has an axle hole 21 and a cam slot 24 to move the connection pin 23 by means of edge 34.

FIG. 13 is a plain top view of the assembled locking tool of this invention with a fourth handle piece 22 and direct connection piece 25 to the common axle 6, while the fourth handle is attached to a leveragable jaw head 19 and a cam wheel 35 located on the forth handle piece 22 to move the connection 25 at pin 23 closer through a slot 24 on 22 to the jaw addition

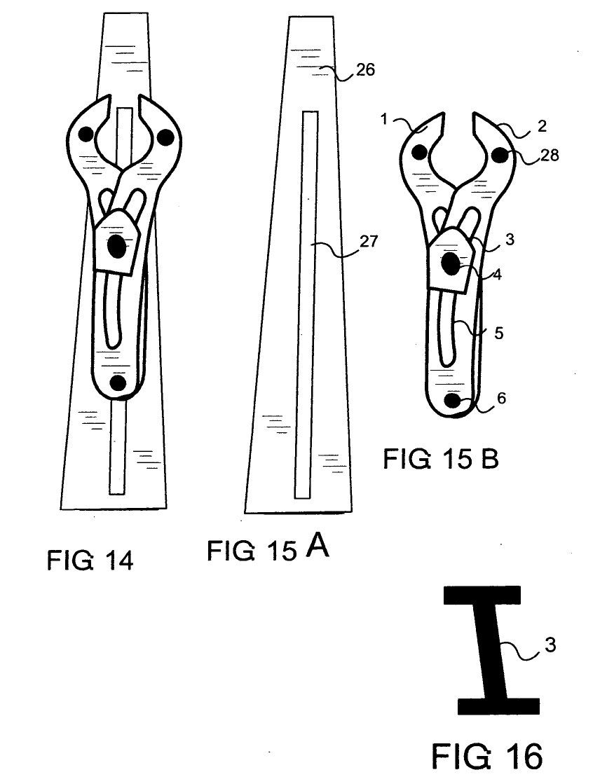

FIG. 14 is a plain top view of the assembled locking tool of this invention placed on a V Edged object 26 with the jaw position attached 28 to an associated position along the V like edge, while the common axle and third piece pin ride an optional cam down the center cam 27

FIG. 15 A shows a top view of the V like edge piece 26 with a center cam like slot 27 that the axle 6 and pin 4 ride in from FIG. 15 B.

FIG. 15 B shows the assemble locking tool of this invention that would be connected to the edges of V like edge piece 26 by attachment pins 28, and in the center cam or slot 27 by axle 6 and holding pin 4.

FIG. 16 is a side view of a third piece pin acting as the third piece 3 holding its own angle by means of angled end caps.

What is claimed is:

1. A locking tool comprising at least two movably-connected pieces, a first handle piece, a second handle piece and at least one third piece, said first handle piece having an upper and/or lower down the handle, jaw portion, below said upper jaw portion an axle aperture and at least one arc-like slot positioned at a point below said axle aperture, said second handle piece having an upper and/or lower down the handle, jaw portion and below said jaw portion an axle aperture, and below said axle aperture at least one vertically-disposed slot, said third piece having a pin holding hole at any angle desired and directed, riding through the arc-like slots of the first and second handle pieces, when said first handle piece and said second handle piece and said third piece are assembled in said locking tool, said jaw portions in said first and second handle pieces having complementary jaw portions that cooperate to form thereby but not limited to a gripping, cutting or crimping means in a bi-directional manor, and a locking pin positioned through each of said arc-like and through the hole in the third piece in either a vertical or horizontal direction.

2. The locking tool of claim 1 wherein said third piece having at least one diagonal hole is positioned sandwiched between said first handle piece and said second piece or outside same.

3. The locking tool of claim 1 wherein multiple layers of all three plates can be stacked and aligned to assist locking angle of third piece pin. and said stack can be rotated around the axle and or cam pin by external means for various leverage advantages.

4. The locking tool of claim 1 wherein said third piece with said diagonal hole for a pin can be effectively augmented with filling pieces for the arc-like slots on the first and second piece, for both ease of movement and/or to asset in obtaining a locking angle in said arc-like slots

5. The locking tool of claim 1 having at least one arc-like slot in said first handle piece, at least one arc-like slot in said second piece, and at least diagonal hole in said third piece.

6. The locking tool of claim 1 wherein said arc-like cam slots and third piece holes are positioned below or above said axle apertures in each of said first handle piece, said second handle piece and said third piece, relative to jaw position.

7. The locking tool of claim 1 wherein a variety of linkage capable of moving piece three in a leveraged manor whether automatic as in controlled by outside regulator influences or manually.

8. The locking tool of claim 1 wherein a said forth handle can use a cam slot at the axle of the first handle to hold the axle in a variety of positions on the second handle piece, with cam edge at different angles relative to the two axle points for differences in both speed of use and flattened cam edge holding ability

9. The locking tool of claim 1 wherein said forth handle can have multiple segments and linkage and cams from a variety of locations around the tool affecting the first against the second handle pieces axle movement or rotation.

10. The locking tool of claim 1 wherein jaw or external connection location can be made at either side and both sides of main axle of the tool and additional jaws or connections can be associated and thereby controlled by the first and second jaw plates.

11. The locking tool of claim 1 wherein the third piece may be a strip with a diagonal pin hole, wherein the strip maybe held by one of the handle pieces, by guides, by the common axle, and additional pins, allowing it vertical motion, and may contain gear like teeth along the edge for use with a ratcheting method, or other connection means and may affect pin angle and thereby rotation of plates along the cam pin or axle.

12. The locking tool of claim 1 wherein wedges, and other means may be used to modify the diagonal angle of the hole and pin in piece three, including but not limited to the angle of the pin ends or pin caps at an angle relative to the slots.

13. The locking tool of claim 1 wherein surface area of either or both of the first and second piece can be modified as to surface type and angle relative to the third piece, to affect a change of diagonal angle of the hole and pin in piece three, or increase or decrease the amount of friction affecting the third piece.

14. The locking tool of claim 1 wherein over center linkage may be added to one or more of the jaw section by extending the handle section of the linkage beyond the handle to jaw connection, so that the primary leveraging handle of such linkage can be rotated in both rotational directions as in a toggle, to effectively open and close jaw or other linkage, in such a manor to effect an over center lock or to allow squeezing on the jaw section. Such toggle like handle to have optional adjustable or permanent limit blocking or notches for beginning and or intermittent positions affecting pressure adjustment in an over center locking mode.

15. The locking tool of claim 1 wherein over center linkage may be added to one or more of the jaw section by extending the handle section of the linkage beyond the handle and into the jaw connection, so that the primary leveraging handle of such linkage can be rotated in both rotational directions as in a toggle, to effectively open and close jaw or other linkage, in such a manor to effect an over center lock or to allow squeezing on the jaw section, eliminating or augmenting spring opening of the linkage and jaw.

16. The locking tool of claim 1 wherein attachments on the jaw ends of the first plate and the second plate can connect to V like bar or cam slots or but not limited to any bar, cam, wire, or rod with a varied edge, such that the jaw opening amount is reflected and corresponds to the position along the V edges, such that positioning and/or motion of the third plate cam pin can ride along the edges at different opening and closing positions and lock in any position.
